(19) United States
(12) Patent Application Publication
(10) Pub. No.: US 2023/0311255 A1
(43) Pub. Date: Oct. 5, 2023

(54) SYSTEM FOR HOLD, CLAMP AND POSITION OBJECTS

(71) Applicant: CNC ILERI TEKNOLOJI MOHENDISLIK SANAYI VE TICARET LIMITED SIRKETI, Istanbul (TR)

(72) Inventors: Yair GELLER, Istanbul (TR); Feza GOKISIK, Istanbul (TR)

(73) Assignee: CNC ILERI TEKNOLOJI MOHENDISLIK SANAYI VE TICARET LIMITED SIRKETI, Istanbul (TR)

(21) Appl. No.: 18/042,223

(22) PCT Filed: Aug. 25, 2020
(86) PCT No.: PCT/TR2020/050757

§ 371 Date: Feb. 20, 2023

(51) Int. Cl. B23Q 1/00; B23Q 3/10

(52) U.S. Cl. CPC B23Q 1/0072; B23Q 3/103

(57) ABSTRACT

The invention relates to to object holding and positioning system that is used for the purposes of clamping, locking, fixing, positioning, conveying, gripping, holding, pushing or pulling the object in the fields of machine tools, machining centers, turning machine, transfer line, metal machine, robot, robot arms, robot hands, rotary tables, fixtures etc. and that enables the holders (T) holding the objects (P) to be locked on the machine tables or robots by means of the link elements (S) and at the same time to be locked.

### BACKGROUND OF THE INVENTION

### Technical Field

The invention relates to the systems used for clamping, locking, fixing, positioning, conveying, gripping, holding, pushing or pulling the objects in machine tools, machining centers, turning machine, transfer line, metal machine, robot, robot arms, robot hands, rotary tables, fixtures etc.

The invention particularly relates to an object hold, clamp and position system which enables directly or through holders holding the object to be positioned and clamped on the machine or robots by means of pull the link elements, and at the same time to be locked by the slider.

### Prior Art

Today, objects are placed on the devices for gripping, holding or pulling object in the areas of machine tools, transfer lines, rotary tables, fixtures etc. and also clamping mechanisms are used to fix like holders on machines.

The clamping mechanisms used in the present art generally have a ball mechanism that clamps on the holders by means of the link element. Like link element, which is connected to the holder at one end of it and also called pull stud, is fixed to the clamping mechanism so that it can be removed from the other circular shaped end. The ball mechanism, which performs the fixing process to the link element in the clamping mechanism, in general structure, has a body, a plurality of balls surrounding the inner surface of the body and a spring assembly that ensures the ball remains in

the locking position continuously. The balls are kept in the locking position continuously by means of the spring assembly and are clamped by gripping the end of the link piece located inside the body. In order to be able to apply opening force to the balls, it is provided that the balls are passed to the open position by using pressurized oil or air. However, in accordance with the working principle of ball

mechanisms in compression systems in the state of the art, only the clamping process is carried out by means of the ball mechanism and the locking process is realized by this clamping process. Therefore, the only effective clamping process in which the ball mechanism performs with balls in especially heavy work pieces, may lead the system not to operate safely.

As an example of the state of the art in the research performed in the literature, document numbered DE10118809 A1 can be shown. Said document relates to the quick-clamping device. In the said invention, it is mentioned that the nipple used as the interconnection element is clamped to the central receiver hole of the cylinder by means of the balls placed circumferentially in the cylinder. In order to clamp the nipple releasably into the cylinder, a suction duct is opened that allows oil or air to be delivered to the center of the cylinder.

As an example of the state of the art, document numbered DE10118808 A1 can be shown. Said document relates to a ball-pool quick-clamping device. In the said

invention, the balls, which are placed in the cylinder in the circumferential direction, are clamped to the interconnection element by the piston moving under the action of the energy accumulator. With the said invention, the balls are allowed to be clamped to the interconnection members having large locking sections and large locking depths.

As an example of the state of the art, document numbered DE10317350 A1 can be shown. Said document relates to a quick-action clamping cylinder consisting of a housing and a cover which covers the housing and has a central recess for receiving an insert nipple that is arranged on the lower side of a workpiece pallet. Said insert nipple is locked in a spring-loaded manner in the housing by means of a plurality of locking balls that are spring-loaded in the locking position on the outer periphery of the insert nipple. Said locking balls are disengaged from the insert nipple in the unlocked position by means of displacement of a piston actuated by a pressurised medium.

In all the above-mentioned documents, systems that performs only the clamping process to the interconnection element connected to the holder holding the work piece are mentioned. Therefore, in the state of the art, a need arises for a system that is clamped to the holder holding the work piece and can be locked at the same time.

As a result, the existence of the above problems and the inadequacy of the existing solutions made it necessary to make a development in the relevant technical field.

### Object of the Invention

The present invention relates to a self-clamping system that overcomes the above-mentioned disadvantages and brings new advantages to the relevant technical field.

The main object of the invention is to obtain an object hold, clamp and position system which enables directly objects or through holders holding the object to be clamped on the machines or robots by means of pulling link element, and at the same time to be positioned, oriented and locked by the inclined slider.

The object of the invention is to provide a single or double acting clamping system according to the field of use.

Another object of the invention is to provide an object hold, clamp and position system driven by hydraulic, pneumatic or servo.

Another object of the invention is to ensure that conveying, gripping, holding, pushing, pulling or transferring processed of the objects are performed safely by self-locking inclined slider which has form closed geometry.

The structural and characteristic features and all the advantages of the invention will be more clearly understood thanks to the figures below and the detailed description written by referring to these figures. For this reason, the evaluation should be made by taking these figures and detailed description into consideration.

### BRIEF DESCRIPTION OF FIGURES

FIG. 1: The perspective view of the object hold, clamp and position system.

FIG. 2: The perspective view of the object hold, clamp and position system from a different angle.

FIG. 3: The perspective view of the object hold, clamp and position system in an alternative usage wherein lock system directly holds the object without using any holder.

FIG. 4: The perspective view of the lock system according to the invention in

disassembled, exploded condition.

FIG. 5: Another view of the lock system according to the invention in disassembled condition.

FIG. 5a: The detailed perspective view which is also given in FIG. 5.

FIG. 5b: The detailed perspective view of the roller cage.

FIG. 6: The view of the lock position and orientation system according to the invention with the lid open.

FIG. 7: The perspective view of the lock system according to the invention.

FIG. 8: The perspective view of the robot gripper in the alternative embodiment of the invention.

FIG. 9: The perspective view of the robot gripper in the alternative embodiment of the invention in disassembled condition.

FIG. 10: The cross-sectional view of the lock system according to the invention.

FIG. 11: The cross-sectional view of the robot gripper in the alternative embodiment of the invention.

FIG. 12: The perspective view of the holder.

FIG. 12a: The perspective view of the holder from a different angle.

FIG. 12b: The perspective view of a structure which can be used alternatively as a holder.

FIG. 12c: The perspective view of a vise which can be used alternatively as a holder.

FIG. 12d: The view showing various forms of the penetrating inserts.

FIG. 12e: The view showing various positions (angles) of the penetrating inserts.

FIG. 13: The perspective view of a window type holder, which can be alternatively used instead of other holders.

FIG. 13a: The perspective view of a serrated type holder which is used to clamp thin objects.

FIG. 13b: The perspective view, from different angle, of the serrated type holder which is used to clamp thin objects.

FIG. 13c: The perspective view of a holder having serrated jaws, which can be alternatively used instead of other holders.

FIG. 14: The perspective view showing the Touch Probe is connected to the robot with Pull-Gripper.

FIG. 14a: The perspective view showing the Lock Systems placed on the ground are touched on the robot by means of the touch sensor placed with the Pull-Gripper and the plane is created.

FIG. 14b: The perspective view showing the robot grabs the object from the link element with the pull-gripper and drops it on the Lock Systems.

FIG. 14c: The perspective view showing the robot touches the first assembled part with the touch probe.

### THE DESCRIPTION OF THE PIECE REFERENCES

10. Main body
11. Main guide hole
12. Cylinder hole
13. Bearing guide rings
20. Side cover
30. Inclined housing
31. Piston
32. Inclined slider
321. T shaped channel
322. Roller Cage
323. Rollers
40. Clamping mechanism
41. Conical Chamber
411. Extension
42. Roller
43. Support Disc
44. Lower body
441. T shaped slide
442. Intermediate rod
50. Guide cover
501. Flat seat surface
502. Diameter hole
503. Orientation hole
504. Air outlet hole
60. Intermediate body
70. Connection element
A. Lock System
S. Link element
T. Holder
T1.Orientation Pin
T2. Orientation hole
T3. Penetrating Insert
T4. Penetrating edge
P. Object
B. Robot gripper
B1. Pin
W. Window type holder
D. Serrated teeth type holder
D1. Jaw
D2. Serrated Teeth Structure
D3. Protrusion
D4. Recess
E. Holder with serrated jaws
E1. Carbide bulges

### DETAILED DESCRIPTION OF THE INVENTION

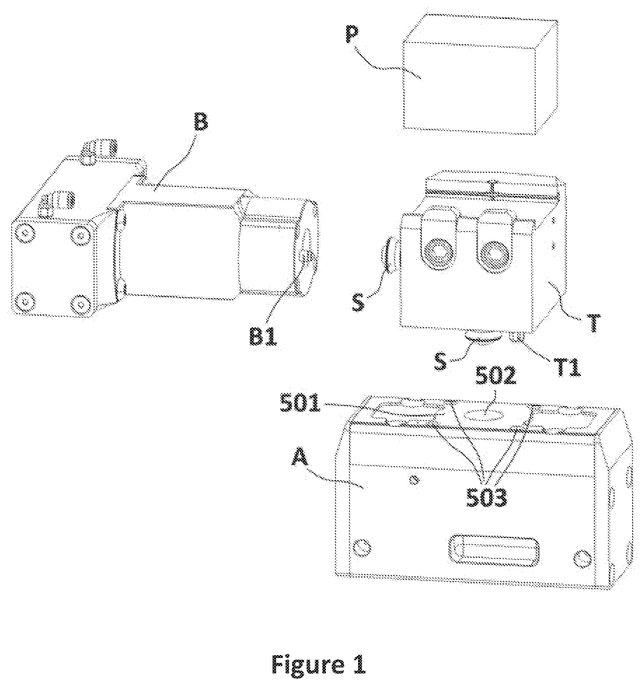

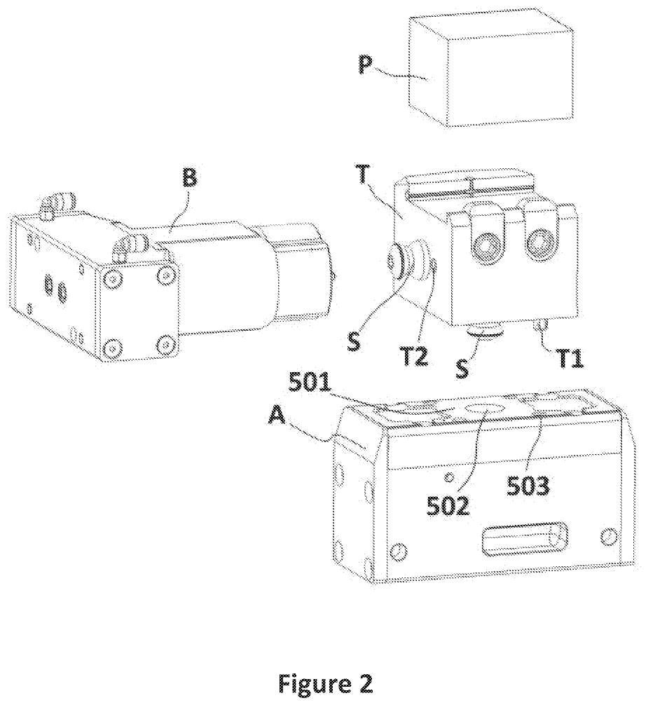

FIG. 1 and FIG. 2 show the perspective views of the object hold, clamp, orient and position system from different angles.

The system is suitable for clamping and holding or clamping, holding and positioning or clamping, holding, positioning and orientation.

As it seen in FIG. 1 and FIG. 2, the invention particularly relates to an object holding and positioning system which enables through holders (T) holding the object

(P) to be positioned, oriented and clamped on the machine or robots by means of pull the link elements (S), and at the same time to be locked by a lock system (A) or a robot gripper (B).

In a preferred embodiment, holder (T) includes at least one pin (T1) which engages into at least one orientation hole (503) of the lock system (A) to provide exact position and orientation of the object (P).

A robot gripper (B) can be used also individually or together with the lock system (A). In this case, at least one pin (B1) which is formed on the robot gripper (B) engages into an orientation hole (T2) formed on the holder (T) to provide exact position and orientation of the object (P).

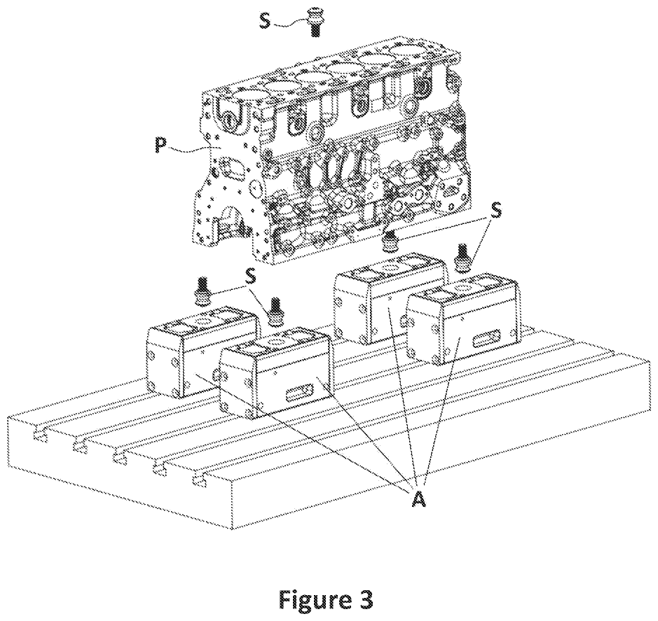

FIG. 3 shows the perspective view of the object hold, clamp and position system in an alternative usage, wherein, multiple lock systems (A) directly hold the object (P) through the link elements (S) without using any holder (T) also holding and clamping by the robot arms with a robot gripper (B).

In this detailed description, the preferred alternatives of the lock system (A) and robot gripper (B) according to the invention are described only for a better understanding of the subject and in such a way that they will not create any conflict effect.

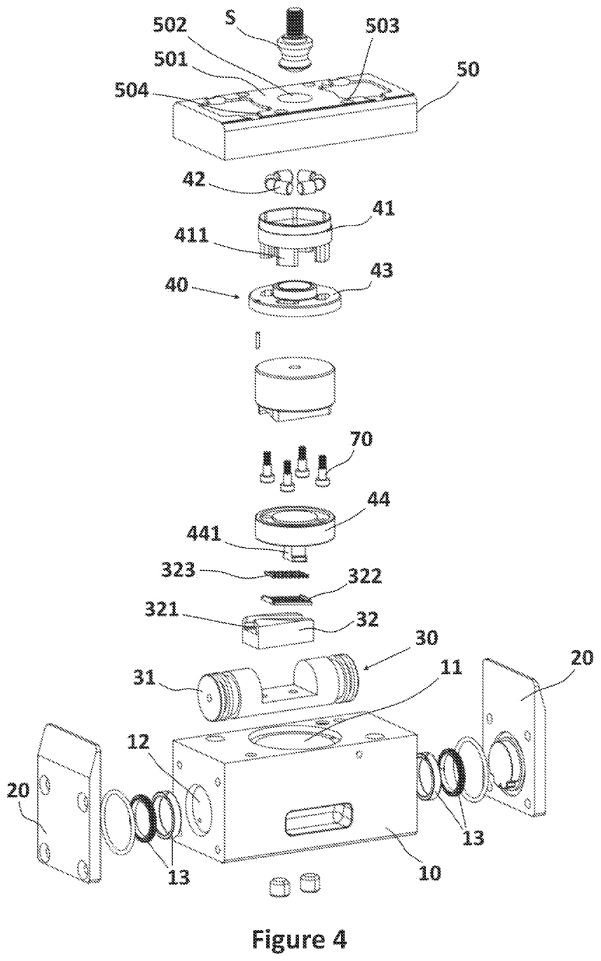

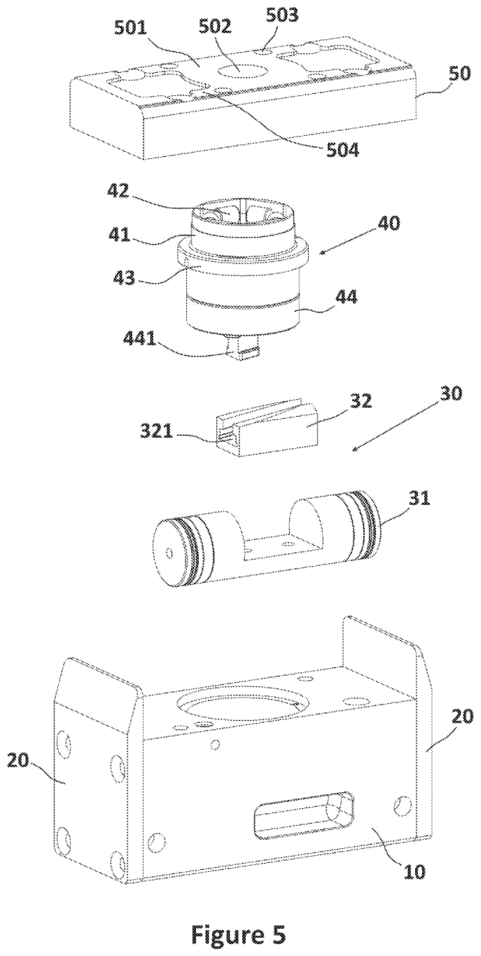

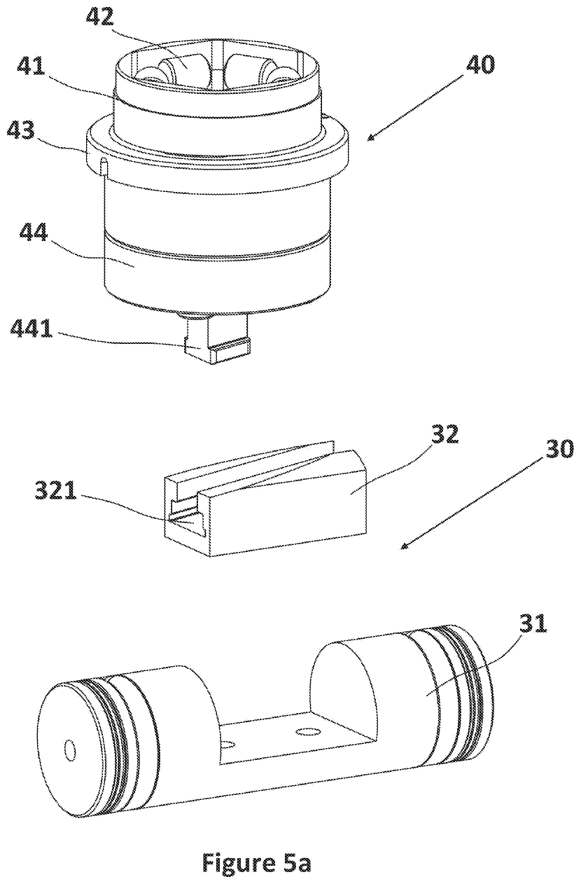

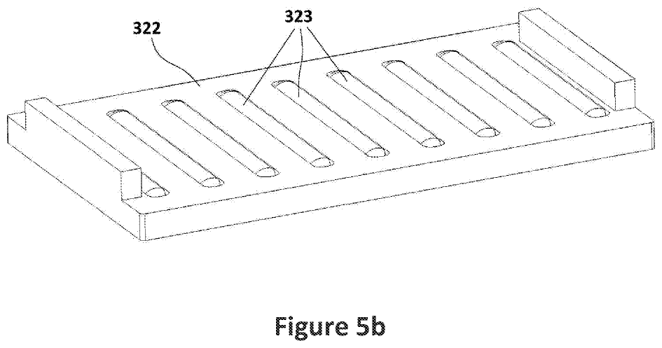

In FIGS. 4 and 5, a disassembled view of the lock system (A) related to the invention is given. Accordingly, the lock system (A) principally contains a main body (10) having a cylinder hole (12) in which air or oil is introduced with hydraulic or pneumatic sources, side cover (20) connected to the main body (10) side surfaces by means of connection element (70), inclined housing (30) includes a piston (31) moving back and forth in the cylinder hole (12), a clamping mechanism (40) pulls the link element (S) down and that engages with the inner surface of it by moving back and forth in the main body (10) and at the same time that is locked with the back and forth movement of the inclined housing (30) and the guide cover (50) connected on the main body (10) by means of the connection element (70).

The main body (10) is the main structure of the lock system (A) according to the invention and has a cylinder hole (12) in which air and oil is introduced. The side cover (20) is sealed to the side surfaces of the main body (10) by means of the connection element (70).

An inclined housing (30) has been placed in the cylinder hole (12) inside the main body (10), so that it can move back and forth. Said inclined housing (30) generally consists of a piston (31) in circular form and an inclined slider (32) connected to the inside of the piston (31). On the inclined slider (32), there is an inclined T shaped channel (321) having a sloped structure. The slope of said inclined T shaped channel (321) is 7° or less than 7°.

As it seen in FIG. 5b, friction decrease elements are used such as a roller cage (322) having rollers (323) on it, which is made up of material with low friction coefficient on mating surface of female T shaped channel (321) with T shaped slide (441) and bearing guide rings (13) between piston and cylinder housing.

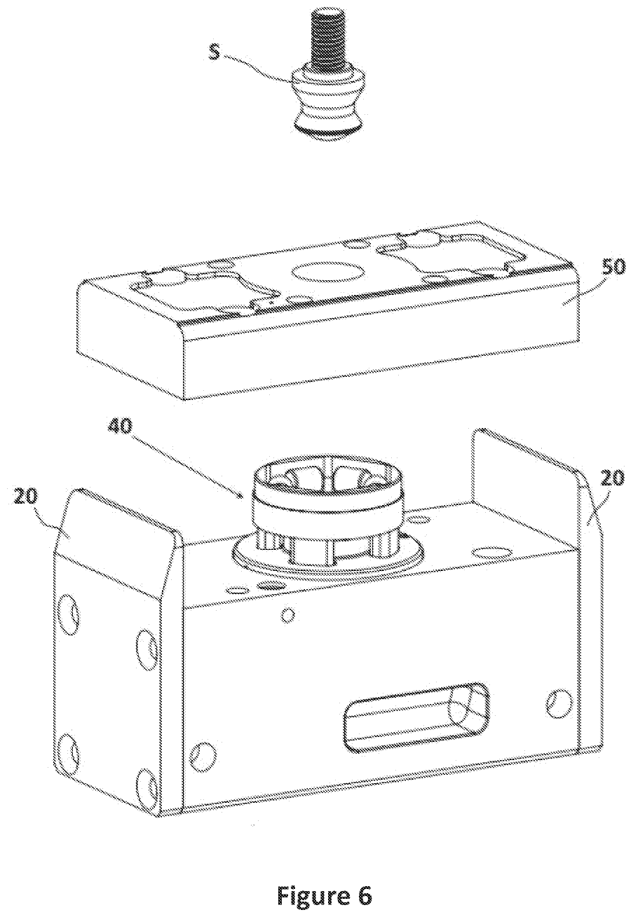

As can be seen in FIG. 6, a clamping mechanism (40) is placed on the main body (10) to be associated with the inclined housing (30). Said clamping mechanism (40) consists of the conical chamber (41), which has an inner surface in a circular form to clamp the link element (S) and which has extensions (411) on its lower surface, a plurality of rollers (42) which surround the inner surface of the conical chamber (41) and roll on its inclined surface of the link element (S), the support disc (43) which freely engages the extensions (411) on the lower surface of the conical chamber (41) and the lower body (44) located under the support disc (43) and moving up and down in connection with the lower surface of the extensions (411) by means of connection elements (70). There is a “T” shaped slide (441) on the lower surface of the lower body (44). Said “T” shaped slide (441) can move back and forth in the T shaped channel (321) of the inclined slider (32) in the inclined housing (30). Thus, the clamping mechanism (40) moving back and forth, which clamps the link element (S) by means of the rollers (42) surrounding the inner surface of the conical chamber (41) and them conical chamber (41), is provided to lock the link element (S) by moving the T shaped slide (441) back and forth in the T shaped channel (321) of the inclined slider (32). Movement of the T shaped slide (441) back and forth in the T shaped channel (321) of the inclined slider (32), is obtained through that the air or oil transmitted into the main body (10) by sources such as hydraulic, pneumatic or servo motors.

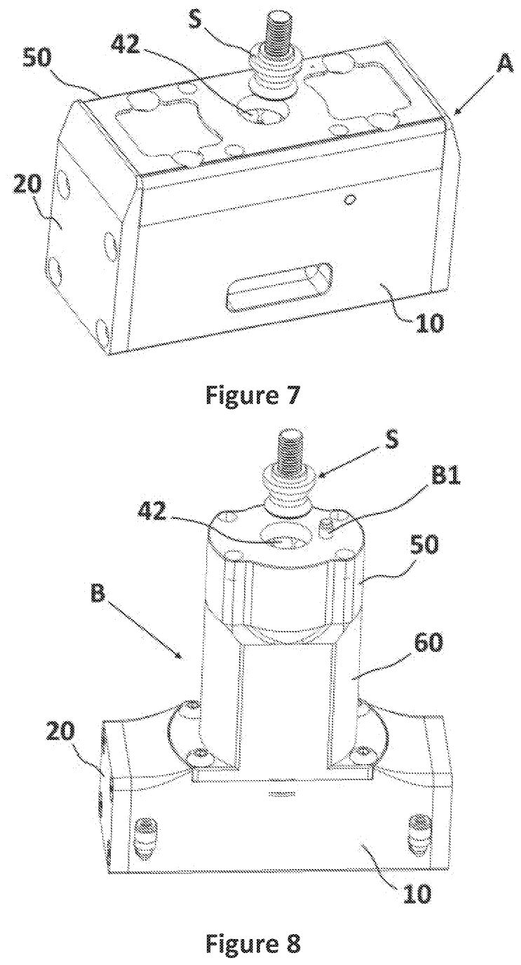

As seen in FIG. 7, the upper surface of the main body (10) is plated and sealed by the cover (50) on the main body (10) by means of the connection element (70).

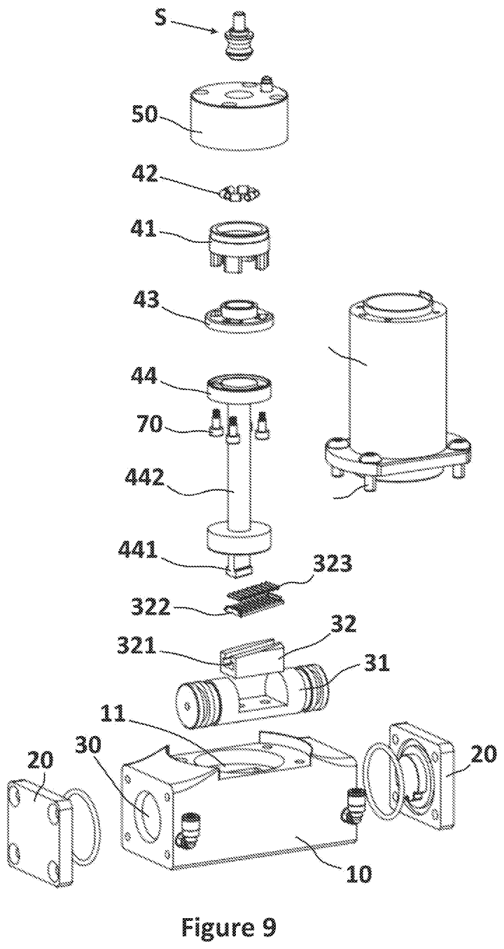

The lock system (A) of the invention can be used on the machine table and also in an alternative embodiment of the invention, it can also be used on robots as a robot gripper (B). In this case, as seen in FIGS. 8 and 9, an intermediate rod (442) is formed on the lower surface of the lower body (44) and the T shaped slide (441) is provided to extend downward from the bottom surface of the intermediate rod (442). Thus, the length of the clamping mechanism (40) is extended on the main body (10). Also in case that a robot gripper (B) is used, the clamping mechanism (40) is provided to be positioned within the intermediate body (60) by means of connecting an intermediate body (60) between the main body (10) and the guide cover (50) by means of the connection element (70).

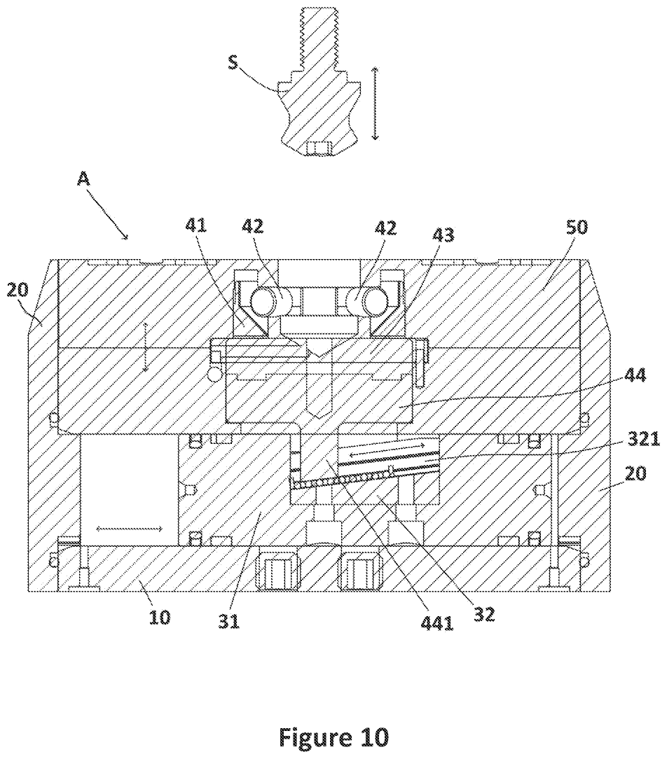

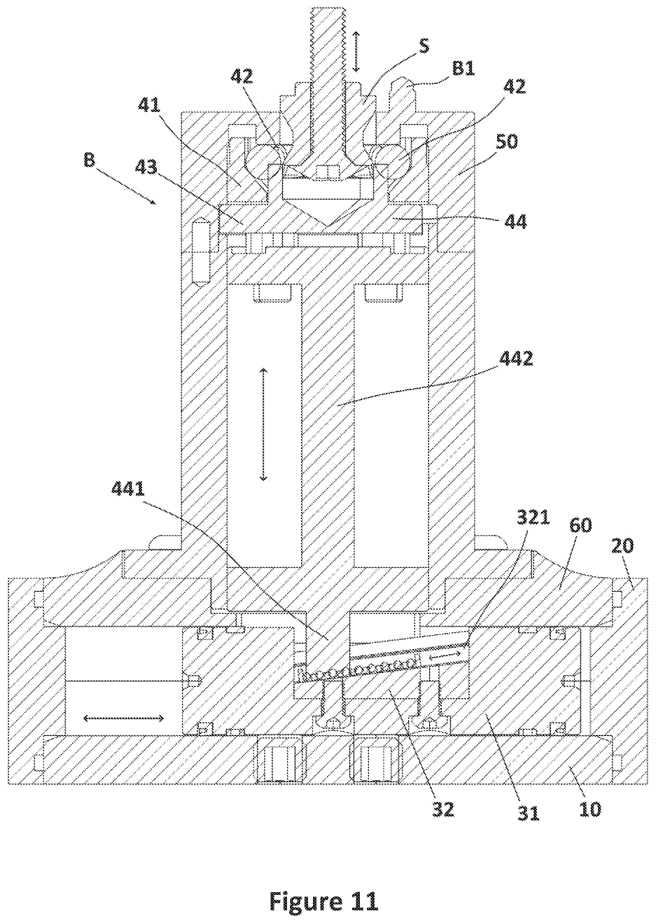

As seen in FIGS. 10 and 11, the working principles of the lock system (A) and robot gripper (B) according to the invention is as follows;

The main body (10) is connected to a source such as hydraulic, pneumatic or servo motor on the machine table or robot.

The link element (S) is positioned downwardly in the conical chamber (41) in the clamping mechanism (40) to engage the link element (S) connected from any surface of it to the holder (T) holding the object (P) from one end with the lock system (A) or the robot gripper (B).

With the link element (S) being positioned inside the conical chamber (41), the link element (S) activates the clamping mechanism (40) and the rollers (42) surrounding the inner surface of the conical chamber (41) roll on the inclined surface of the link element (S). Meanwhile, the conical chamber (41) moves upward within the support disk (43) by means of the extensions (411) passing through the support disc (43) together with the lower body (44) connected to its lower surface. With the upward movement of the conical chamber (41) and the lower body (44), the clamping mechanism (40) is provided to clamp the link element (S) by means of the conical chamber (41) and rollers (42) surrounding the inner surface of the conical chamber (41).

In order for the clamping mechanism (40) to lock the link element (S), the inclined housing (30) is moved inside the main body (10) by means of air or oil transferred into the main body (10). With the movement of the inclined housing (30), the T shaped slide (441) moves in the T shaped channel (321) of the inclined slider (32) with an inclination angle of 7° or less than 7° and the clamping mechanism (40) is provided to lock the link element (S). Hence, the lock system (A) connected to the machine table or the robot gripper (B) of a robot, is connected to the holder (T) holding the object (P).

In the alternative embodiment of the invention, if the clamping mechanism (40) is not wanted to lock the link element (S), the inclination angle of the inclined slider (32) may be more than 7°. The force can be increased or decreased by changing the inclination angle of the inclined slider (32).

The lock system (A) or the robot gripper (B) of the object holding and positioning system, comprises a sloped structure in the form inclined slider (32), it can be a helical slider or double inclined slider which can utilize female form closed channel.

Wedge transmission ratio provides high mechanical advantage, which increase clamp force up to 9 times of actuation piston force. This fact enables the device to be used for variety of pull forces by control cylinder pressure and without changing the device size.

Due to development by two separate mechanism modules device has another usage as robotic gripper (B) arm by simply altering the T bar length. In such a case orientation pin position holes (503) are replaced with two diameter stepped pin (B1) which has conical tip. Again that two diameter stepped pin is precisely located.

The guide cover (50) of the lock system (A) or robot gripper (B), comprises a flat seat surface (501) on the top which has accurate diameter hole (502) in the middle for draw and release of link element (S).

When connected in position link element (S) axis and machining axes are perpendicular, it is possible to machine rectangular prismatic object, normal to 5 of it's surfaces since remainder 6th face has been used to clamp.

In case that we need to machine object opposite/across two face/both side we are able to make it in one clamp to use window type holder (W) wherein said object is positioned inside the window. For example upper surface of the object is machined, after that window type holder (W) is rotated and positioned in desired angle and the other opposite surface can be machined without disconnecting the object (P).

At least one air outlet hole (504) is formed on the flat seat surface (501) for seat check. If the work piece object (P) is not in contact with the flat seat surface (501), pressure drops in seat check line rises in alert.

Piston (31) with inclined slider (32) builds in inclined housing (30) in order to make the system assembly possible via radially inward bolts or any kind of bond to connect the parts through the openings on the bottom of main body (10).

Inclined housing (30) can be adopted to any foot print shape. It does not have to be circular. Ports for pressurized fluid can be placed on three mutually perpendicular surfaces. Even ports may be placed in any angle.

The lock system (A) can also be used as push or pull clamp in perpendicular direction of actuation piston (31). In this case, rollers (42) of the clamp mechanism are not used.

The inclined slider (32) has rectangular shape to restrict rotation of the cylindrical piston (31) assembly about its own axis. There is no physical feature that restrains the angular piston (31) motion about its axis. Hence axial motion of cylindrical piston (31) assembly is protected for rotation in angular direction. The inclined slider (32) and lower body (44) are allowed to move in transverse direction relative to each other.

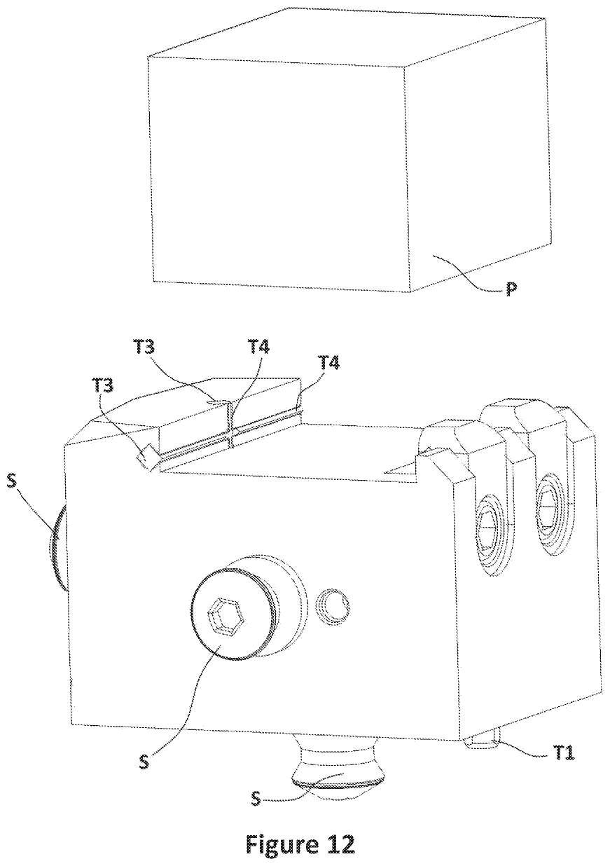

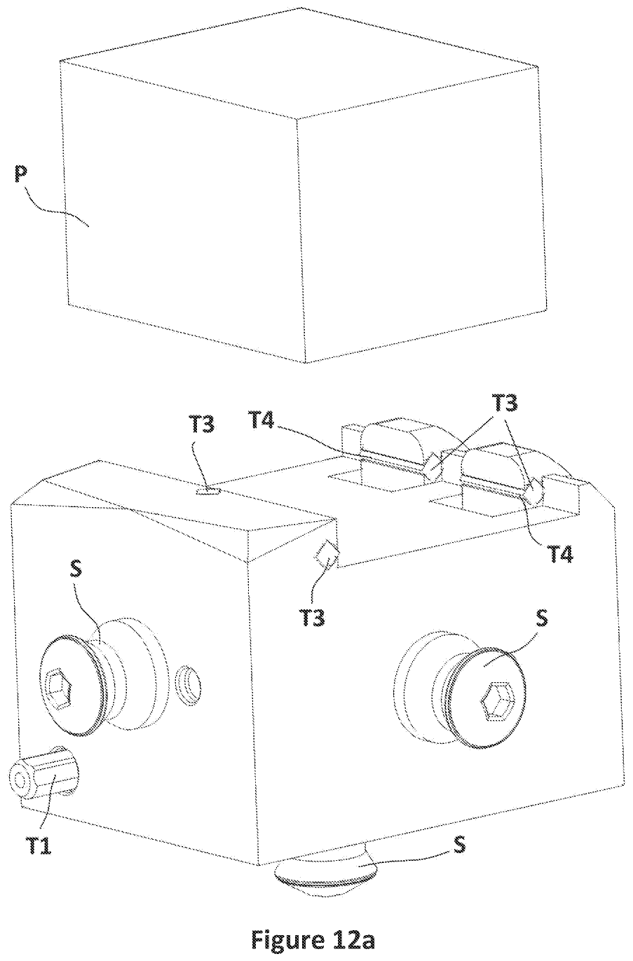

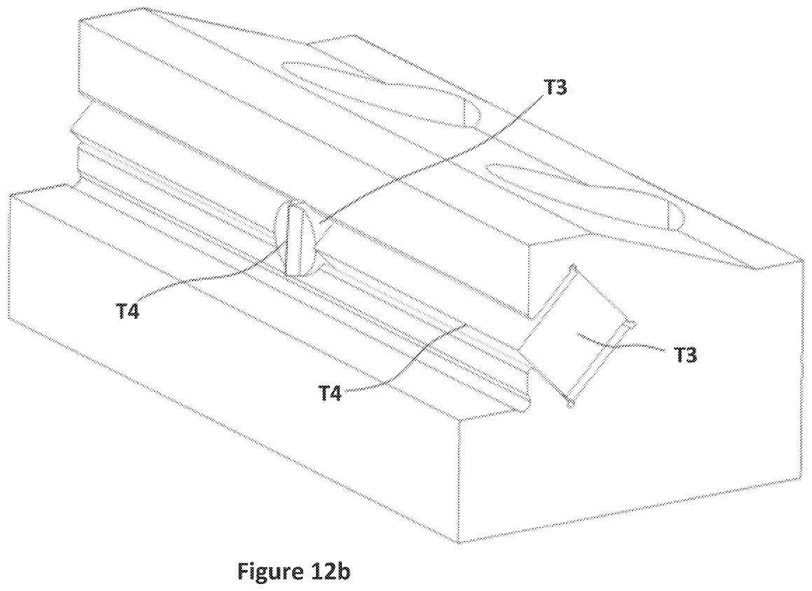

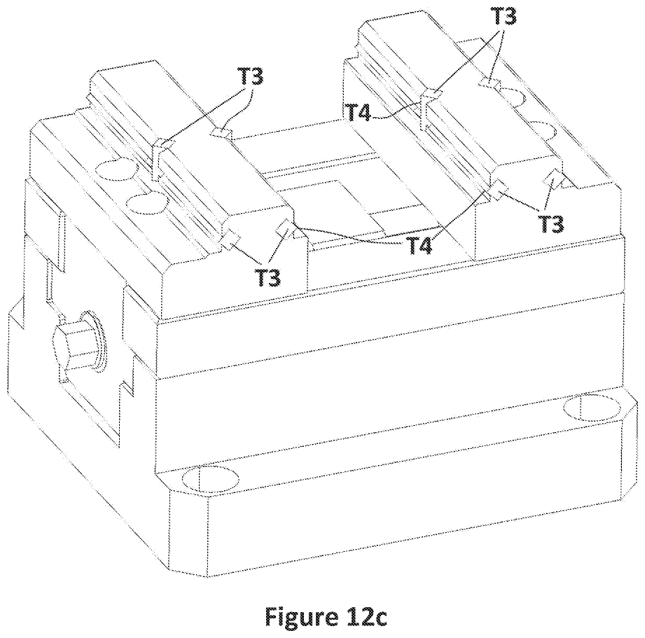

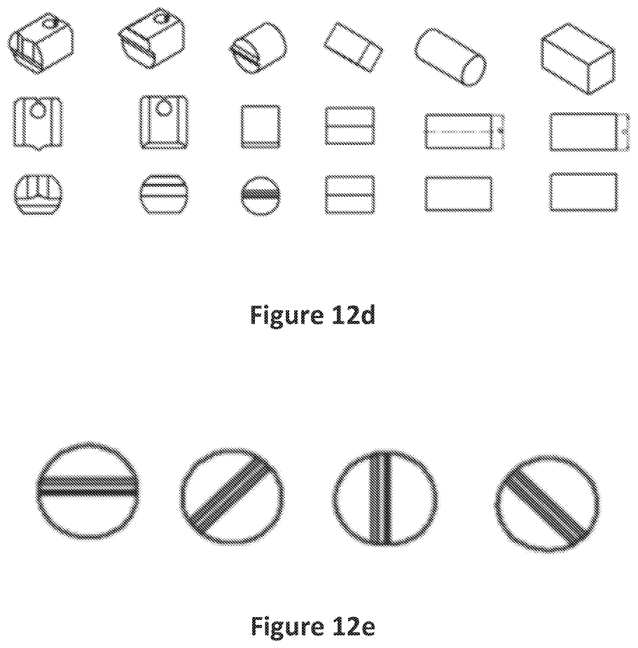

As it seen in FIG. 12, the object holding and positioning system includes a holder (T), said holder (T) holds the object (P) to be positioned and clamped on the machine or robots by means of pull the link elements (S) and at the same time to be locked, wherein said holder (T) includes at least one penetrating insert (T3) having at least one penetrating edge (T4) which is used to prevent the movement of the object (P) on the horizontal and vertical axis and fix it along the both axis by penetrating a certain amount into the surface of the object (P) or by creating friction force on the contact surface in a desired angle. Penetrating insert (T3) is made of bimetal (hard) material, preferably carbide.

If it is needed to machine object opposite/across two face/both side, it can be machined in one clamp to use window type holder (W) wherein, the upper surface of an object (P) is machined, after that window type holder (W) is rotated in desired angle and the other opposite surface of the same object (P) can be machined without disconnecting the object (P) from the holder.

Penetrating inserts (T3) can have square, rectangular, polygonal, triangular, circular cross sections. A montage method such as welding, soldering, press fit, bolt, pin, weld-on is used to mount the fasteners (T3) fixedly on the holder (T) or window type holder (W) or a vise.

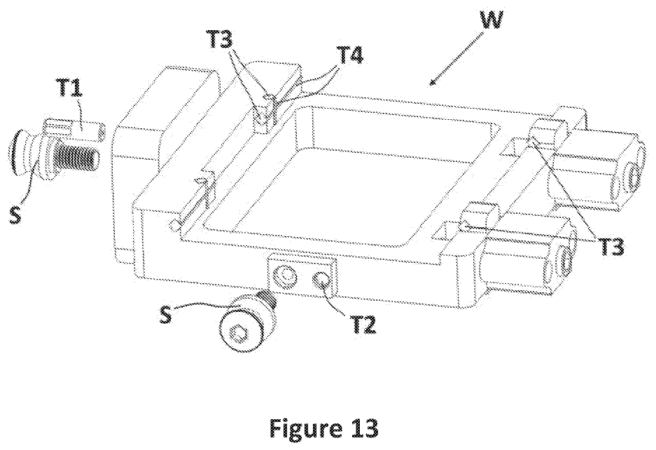

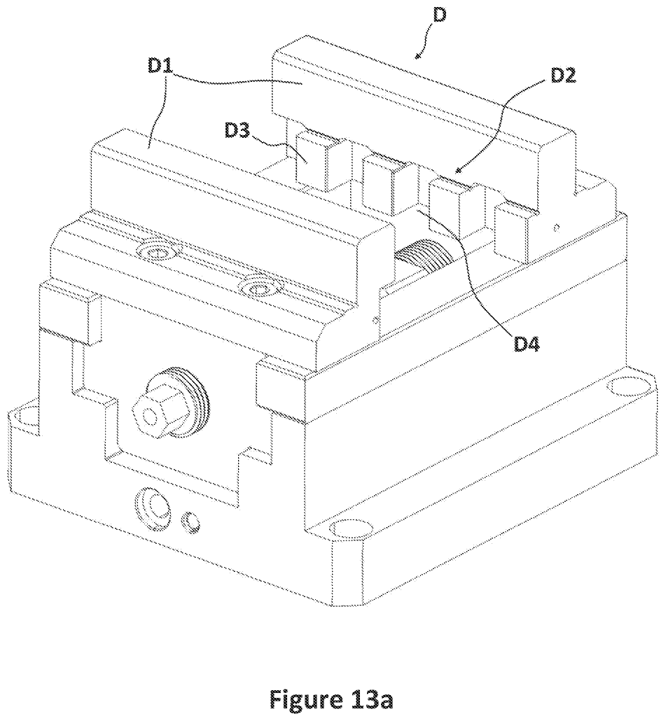

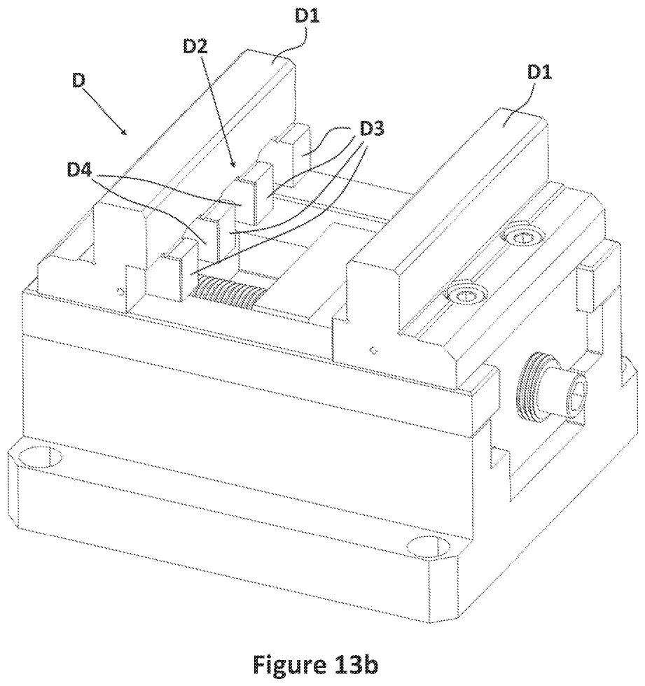

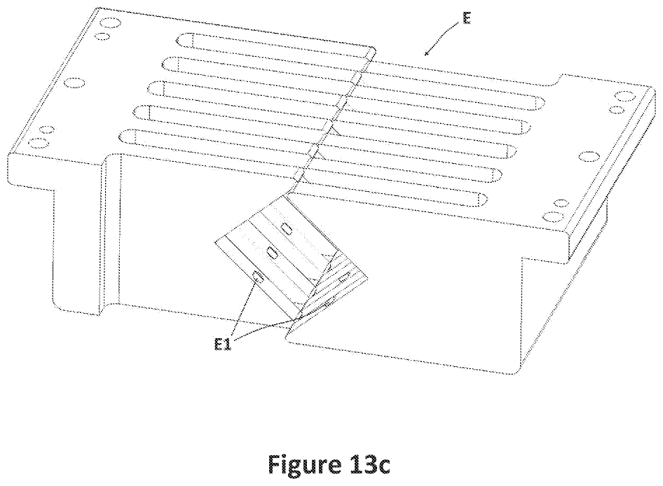

FIG. 13a and FIG. 13b show the perspective view of a serrated teeth type holder (D) which is used to clamp thin objects. When it is desired to use the system for thin parts, the mutual jaws (D1) which have serrated teeth structures (D2) are used for the solution. Serrated teeth structures (D2) includes protrusions (D3) and recesses (D4) which can be engaged into each other to clamp thin parts with zero thickness. As it seen in FIG. 13c, a holder with serrated jaws (E) is used as a holder (T) to clamp objects which have different diameters, wherein said holder with jaws (E) includes carbide bulges (E1) which are used to fix the object by penetrating a certain amount into the surface of the object (P) or by creating friction force on the contact surface.

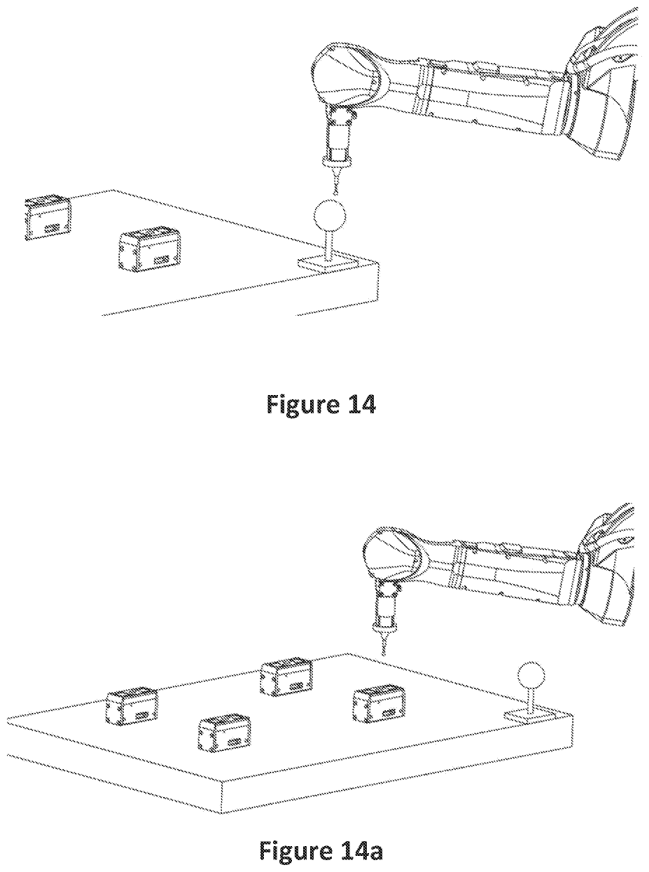

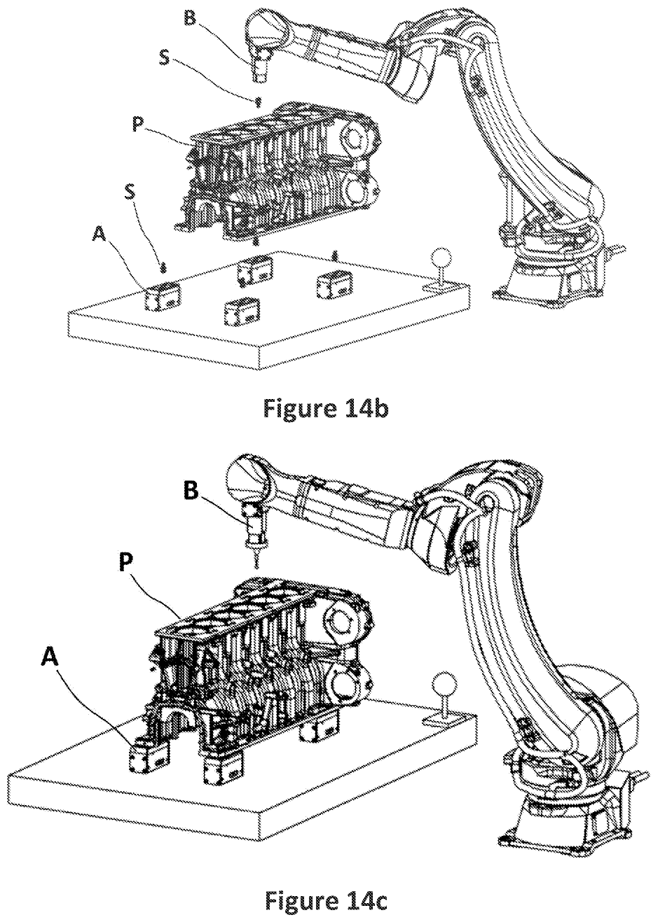

FIG. 14 shows that a touch probe is connected to the robot with Pull-Gripper. Calibration of this probe is made with the calibration piece placed on the ground.

FIG. 14a shows the perspective view showing the lock systems placed on the ground are touched on the robot by means of the touch sensor placed with the Pull-Gripper and the plane is created.

FIG. 14b shows the perspective view showing the robot grabs the object from the link element with the pull-gripper and drops it on the lock systems. For the link elements at the bottom of the cylinder block piece, which is given as an example, the

teeth are opened and the link elements are mounted on the cylinder block. Lock system fixes the cylinder block in the desired place.

FIG. 14c shows the perspective view showing the robot touches the first assembled part with the touch probe. The robot touches (contacts) the first assembled part with the touch probe. The software calculates the difference between the theoretical value and the real value.

### Explanation of the Assembly Line:

Function of assembly line is to connect two components. As example to connect to first component to another component (to connect to main assembly, subassembly)

with required accuracy. On a rigid plane in specific place lock systems (A) are connected, and holes related to the cad data in the first component during production are added to connect link element (S) (from now on where the link elements in the space are known). The main body is located in the this lock system (A) with link element (S) .The other component that need to be connected to the said main body, during production also accurate positioning hole for link element (S) are added. Robot gripper (B), brings the component exactly to the place. To bring the components exactly to the place need to be correlation between the first component to the second component.

It's mean robot need to follow to the solid plane and positioning in the solid plane.

Touch probe sensor connected to the robot gripper (B). The touch probe sensor detects the plane and the positioning of lock system (A) calculates with software the deviation between cartesian coordinate systems by transformation and finds user frame and tool frame. It mean from now on robot and the base is match each other and act as one cartesian coordinate transformation system. This software package can be used separately from lock system.

In assembly lines the purpose is to combine parts or cluster of parts which may require to be connected with accurate position and repeatability.

On a rigid station lock systems (A) are precisely placed. Link elements (S) are installed to accurate correspondent places on the part No 1.

As a result the part No 1 has been positioned in space in close accordance with the theoretical model. Other part No 2 is put on part No 1 with respect to same theoretical model.

Robot transports part No 2 near to part No 1 and positions the part No 2 to be assembled.

As part No 2 is also needed to have precise position resembling the same theoritical model in same space. For this reason another link element (S) is installed on the part No 2.

Touch probe connected via link element (S) to robot gripper side assigns the coordinate frame to part No 1.

The touch probe sensor is used to establish correlation among actual positions of assembly parts and theoretical model.

The auto teaching (Y) software utilizing coordinate frame transformation serves to establish coordinate systems and calculate the relative deviation among them.

With this solution coordinate system attached the robot for part No 1 and the part No 2 are established.

If extra accuracy request to define the gripper frame a stationary touch probe ca be utilized.

This auto teaching (Y) solution can be used with complete solution or separately.

The 3D vector calculation with transformation matrices behind the auto teaching (Y) software is as follows:
TFCS: Tool flange coordinate system of Robot.
PTCP: Tool center point of probe.
Base: Origin of robot.
COORDINATE FRAME ATTACHED TO PART TO BE ASSEMBLED
[TCP_{X} TCP_{Y} TCP_{Z}]_{T} Translation from the origin of the robot tool flange coordinate system to the tool center point.

$$PTCPHTFCS = [ \begin{matrix}1 & 0 & 0 & {TCP}_{x} \\ 0 & 1 & 0 & {TCP}_{y} \\ 0 & 0 & 1 & {TCP}_{z} \\ 0 & 0 & 0 & 1\end{matrix} ]$$

$$TFCS ω HBASE = [ \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34} \\ {a}_{41} & {a}_{42} & {a}_{43} & {a}_{44}\end{matrix} ] = [ \begin{matrix} & {Rot}_{a} & & {t}_{a} \\ 0 & 0 & 0 & 1\end{matrix} ] i ∈ [ 1 … N ]$$

$$TFCS ω HBASE = [ \begin{matrix}{b}_{11} & {b}_{12} & {b}_{13} & {b}_{14} \\ {b}_{21} & {b}_{22} & {b}_{23} & {b}_{24} \\ {b}_{31} & {b}_{32} & {b}_{33} & {b}_{34} \\ {b}_{41} & {b}_{42} & {b}_{43} & {b}_{44}\end{matrix} ] = [ \begin{matrix} & {Rot}_{b} & & {t}_{b} \\ 0 & 0 & 0 & 1\end{matrix} ] j ∈ [ 1 … N ]$$

(i and j represent different robot positions from 1 to N.)
TFCS(i) HBASE×PTCPHTFCS=TFCS(j) HBASE×PTCPHTFCS

a₁₁TCP_{X}a₁₂TCp_{y}a₁₃TCP_{z}+a₁₄b₁₁TCP_{X}+b₁₂TCP_{y}b₁₃TCP_{z}+b₁₄[(Rotₐ−Rot_{b})]×[TCPXTCPYTCPX]^{T}=−[t_{ā}−t_{b̅}]
Using in at least three different robot positions, the above equation is applied to find TCPx, TCPy, TCPz. Thus, PTCPHTFCS is obtained.
COORDINATE SYSTEM ATTACHED THE ROBOT FOR PART NO 1
PLANEHBASE: Homogeneous Transformation Matrix of plane in related to base of robot.
TFCSHBASE: Homogeneous Transformation Matrix of tool flange coordinate system in related to base of robot.
PTCPHTFCS: Homogeneous Transformation Matrix of tool center point of probe in related to tool flange coordinate system of robot.
TFCSHBASE→BASEHTFCS
PTCPHTFCS→TFCSHPTCP
BASEHTFCS×TFCSHPTCP=BASEHPTCP
PLANEHBASE×BASEHPTCP=PLANEHPTCP
BASEHPTCP→PTCPHBASE
PLANEHPTCP×PTCPHBASE=PLANEHBASE

This formula useable to define coordinate frame for any object in the space.

What is claimed is:

1. An object holding, clamping, positioning and orientation system which is used to hold, clamp, position and orient the objects (P), characterized in that it comprises
at least one holder (T) holding the object (P) to be positioned and clamped on the machine or robots by means of pull the link elements (S) and at the same time to be locked by a lock system (A) or a robot gripper (B), wherein,
the holder (T) includes at least one pin (T1) which engages into at least one position hole (503) of the lock system (A) to provide exact position and orientation of the object (P), or
if a robot gripper is used instead of a lock system (A), in this case at least one pin (B1) which is formed on the robot gripper (B) engages into an orientation hole (T2) formed on the holder (T) to provide exact position and orientation of the object (P).

2. An object holding and positioning system according to claim 1, characterised in that it comprises lock systems (A) directly hold the object (P) through the link elements (S) without using any holder (T).

3. A lock system (A) or a robot gripper (B) of an object holding and positioning system, which are used for clamping, locking, fixing, positioning, conveying, gripping, holding, pushing or pulling the object (P) in machine tools, machining centers, turning machine, transfer line, metal machine, robot, robot arms, robot hands, rotary tables, fixtures etc. and that enables directly or through holders (T) holding the object (P) to be positioned and clamped on the machine or robots by means of pull the link elements (S) and at the same time to be locked, characterised in that it comprises;
a main body (10) having a cylinder hole (12) in which air or oil inlet is introduced with hydraulic or pneumatic sources,
side cover (20) connected to the main body (10) side surfaces,
a piston (31) with a inclined slider (32), which moves back and forth in the cylinder hole (12) by means of air or oil transferred into the main body (10) and has an inclined T shaped channel (321) on it,
the upward-downward clamping mechanism (40) which has the upward-downward moving conical chamber (41) with more than one roller (42) rolling on the inclined surface of the link element (S) in the inner surface to ensure the link element (S) to be pulled, the support disc (43) that freely engages the extensions (411) on the lower surface of the conical chamber (41), the lower body (44) that is connected to the lower surface of the extensions (411) and moves up and down on the lower surface of the support disc (43) with the conical chamber (41) and T shaped slide (441) moving back and forth in the inclined T shaped channel (321) of the inclined slider (32) to ensure that the link element (S) is locked,
a guide cover (50) connected on the main body (10), wherein the guide cover (50) includes a flat seat surface (501), a diameter hole (502) and at least one position hole (503).

4. A lock system (A) or a robot gripper (B) of an object holding and positioning system according to claim 3, characterised in that said inclined housing (30) comprises a piston (31) in circular form and an inclined slider (32) connected to the inside of the piston (31).

5. A lock system (A) or a robot gripper (B) of an object holding and positioning system according to claim 3, characterised in that it comprises a sloped structure in the form inclined slider (32), it can be a helical slider or double inclined slider which can utilize female form closed channel.

6. A lock system (A) or a robot gripper (B) of an object holding and positioning system according to claim 3, characterised in that the slope of said T shaped channel (321) is preferably 7° or less than 7°, but if self-lock is not requested any degree can be used.

7. A lock system (A) or a robot gripper (B) of an object holding and positioning system according to claim 3, characterised in that, with the link element (S) being positioned inside the conical chamber (41) in order for said link element (S) to be engaged, it comprises the conical chamber (41) moving downwardly in the support disc (43) by means of the extensions (411) passing through the support disc (43) with the lower body (44) connected to its lower surface.

8. A lock system (A) or a robot gripper (B) of an object holding and positioning system according to claim 3, characterised in that, it comprises more than one roller (42) rolling on the inclined surface of the link element (S) with the link element (S) located in the conical chamber (41) and providing the clamping mechanism (40) to lock the link element (S) with the upward movement of the conical chamber (41) and the lower body (44).

9. A lock system (A) or a robot gripper (B) of an object holding and positioning system according to claim 3, characterised in that, it comprises the T shaped slide (441) located on the lower surface of said lower body (44) and providing the clamping mechanism (40) to lock the link element (S) by moving back and forth in the female T shaped channel (321) of the inclined slider (32)

10. A lock system (A) or a robot gripper (B) of an object holding and positioning system according to claim 3, characterised in that it has friction decrease elements such as a roller cage (322) having rollers (323) on it, which is made up of material with low friction coefficient on mating surface of female T shaped channel (321) with T shaped slide (441) and bearing guide rings (13) between piston and cylinder housing.

11. A lock system (A) or a robot gripper (B) of an object holding and positioning system according to claim 3, characterised in that, said clamping mechanism (40) comprises an intermediate rod (442) located on the lower surface of the clamping mechanism (40).

12. A lock system (A) or a robot gripper (B) of an object holding and positioning system according to claim 3, characterised in that, if the robotic gripper (B) is used instead of lock system (A), in such a case orientation pin position holes (503) are replaced with pin (B1).

13. A lock system (A) or a robot gripper (B) of an object holding and positioning system according to claim 3, characterised in that it comprises the intermediate body (60) which is connected between said main body (10) and the guide cover (50) and in which the clamping mechanism (40) is positioned.

14. A lock system (A) or a robot gripper (B) of an object holding and positioning system according to claim 3, characterised in that the guide cover (50) comprises a flat seat surface (501) on the top which has accurate diameter hole (502) in the middle for draw and release of link element (S).

15. A lock system (A) or a robot gripper (B) of an object holding and positioning system according to claim 3, characterised in that it comprises at least one position hole (503) on flat seat surface (501) for exact position and orientation of the object (P).

16. A lock system (A) or a robot gripper (B) of an object holding and positioning system according to claim 3, characterised in that, at least one air outlet hole (504) is formed on the flat seat surface (501) for seat check, if the work piece object (P) is not in contact with the flat seat surface (501), pressure drops in seat check line rises in alert.

17. A lock system (A) or a robot gripper (B) of an object holding and positioning system according to claim 3, characterised in that, piston (31) with inclined slider (32) builts in inclined housing (30) in order to make the system assembly possible via radially inward bolts or any kind of bond to connect the parts through the openings on the bottom of main body (10).

18. A lock system (A) or a robot gripper (B) of an object holding and positioning system according to claim 3, characterised in that the inclined slider (32) has rectangular shape to restrict rotation of the cylindrical piston (31) assembly about its own axis wherein there is no physical feature that restrains the angular piston (31) motion about its axis, hence axial motion of cylindrical piston (31) assembly is protected for rotation in angular direction.

19. A lock system (A) or a robot gripper (B) of an object holding and positioning system according to claim 3, characterised in that the inclined slider (32) and lower body (44) are allowed to move in transverse direction relative to each other.

20. A holder (T) of an object holding and positioning system, wherein said holder (T) holds the object (P) to be positioned and clamped on the machine or robots by means of pull the link elements (S) and at the same time to be locked, characterised in that,
Said holder (T) includes at least one penetrating insert (T3) having at least one piercing edge (T4) which is used to prevent the movement of the object (P) on the horizontal and vertical axis and fix it along the both axis by penetrating a certain amount into the surface of the object (P) or by creating friction force on the contact surface in a desired angle.

21. A holder (T) of an object holding and positioning system according to claim 20, characterised in that, the penetrating insert (T3) and the penetrating edge (T4) can be used in vice, fixture, in any kind of holder and wherein any dovetail or groove is not needed on the object (P) with penetrating insert (T3) and piercing edge (T4).

22. A holder (T), vice , fixture of an object holding and positioning system according to claim 20, characterised in that, penetrating insert (T3) is made of bimetal (hard) material, preferably carbide.

23. A holder (T) of an object holding and positioning system according to claim 20, characterised in that, if it is needed to machine object opposite/across two face/ both side, it can be machined in one clamp to use a window type holder (W) wherein, the upper surface of an object (P) is machined, after that window type holder (W) is rotated in desired angle and the other opposite surface of the same object (P) can be machined without disconnecting the object (P)

24. A holder (T) of an object holding and positioning system according to claim 20, characterised in that, penetrating insert (T3) can have square, rectangular, polygonal, triangular, circular cross sections.

25. A holder (T) of an object holding and positioning system according to claim 20, characterised in that, a montage method such as welding, soldering, press fit, bolt, pin, weld-on is used to mount the penetrating insert (T3) fixedly on the holder (T) or window type holder (W).

26. A holder (T) of an object holding and positioning system according to claim 20, characterised in that, a serrated teeth type holder (D) is used as a holder (T) to clamp thin objects, when it is desired to use the system for thin parts, the mutual jaws (D1) which have serrated teeth structures (D2) are used for the solution wherein, the serrated teeth structures (D2) includes protrusions (D3) and recesses (D4) which can be engaged into each other to clamp thin parts with zero thickness.

27. A holder (T) of an object holding and positioning system according to claim 20, characterised in that, a holder with serrated jaws (E) is used as a holder (T) to clamp objects which have different diameters, wherein said holder with jaws (E) includes carbide bulges (El) which are used to fix the object by penetrating a certain amount into the surface of the object (P) or by creating friction force on the contact surface.

28. The object holding and positioning system that enables the holders (T) holding the objects (P) to be clamped on the machines or robots by means of the link elements (S) and at the same time to be positioned, oriented and locked for the purposes of clamping, locking, fixing, positioning, conveying, gripping, holding, pushing or pulling the object in the fields of machine tools, machining centers, turning machine, transfer line, metal machine, robot, robot arms, robot hands, rotary tables, fixtures etc. characterised in that clamping process steps;
Link element (S) is connected to directly to object (P) or to holder (T),
positioning the link element (S) downwards into the conical chamber (41) in the clamping mechanism (40),
position the rollers (42) surrounding the inner surface of the conical chamber (41) on the inclined surface of the link element (S),
moving the conical chamber (41) downward within the support disc (43) by means of the extensions (411) passing through the support disc (43) together with the lower body (44) connected to its lower surface,
with the upward movement of the conical chamber (41) and the lower body (44), clamp of the mechanism (40) to the link element (S) by means of the conical chamber (41) and roller (42) surrounding the inner surface of the conical chamber (41),
moving the inclined housing (30) inside the main body (10) by means of air or oil transferred into the main body (10),
with the movement of the inclined housing (30), moving of the T shaped slide (441) in the female T shaped channel (321) of the inclined slider (32) with an inclination angle of 7° or less than 7° and locking of the clamping mechanism (40) to the link element (S).

29. 3D vector calculation with transformation matrices behind the auto teaching software algorithm of an object holding and positioning system that enables the holders (T) holding the objects (P) to be clamped on the machines or robots by means of the link elements (S) at assembly lines characterised in that,
In order to define the coordinate frame attached to part to be assembled;
Tool flange coordinate system of robot is named as TCFS,
Tool center point of probe is named as PTCP,
Origin of robot is named as Base,
[TCP_{X} TCP_{Y} TCP_{Z}]_{T} defines the translation from the origin of the robot tool flange coordinate system to the tool center point,
$$PTCPHTFCS = [ \begin{matrix}1 & 0 & 0 & {TCP}_{x} \\ 0 & 1 & 0 & {TCP}_{y} \\ 0 & 0 & 1 & {TCP}_{z} \\ 0 & 0 & 0 & 1\end{matrix} ]$$
$$TFCS ω HBASE = [ \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34} \\ {a}_{41} & {a}_{42} & {a}_{43} & {a}_{44}\end{matrix} ] = [ \begin{matrix} & {Rot}_{a} & & {t}_{a} \\ 0 & 0 & 0 & 1\end{matrix} ] i ∈ [ 1 … N ]$$
$$TFCS ω HBASE = [ \begin{matrix}{b}_{11} & {b}_{12} & {b}_{13} & {b}_{14} \\ {b}_{21} & {b}_{22} & {b}_{23} & {b}_{24} \\ {b}_{31} & {b}_{32} & {b}_{33} & {b}_{34} \\ {b}_{41} & {b}_{42} & {b}_{43} & {b}_{44}\end{matrix} ] = [ \begin{matrix} & {Rot}_{b} & & {t}_{b} \\ 0 & 0 & 0 & 1\end{matrix} ] j ∈ [ 1 … N ]$$
(i and j represent different robot positions from 1 to N)
TFCS(i) HBASE×PTCPHTFCS=TFCS(j) HBASE×PTCPHTFCS
a₁₁TCP_{X}a₁₂TCp_{y}a₁₃TCP_{z}+a₁₄b₁₁TCP_{X}+b₁₂TCP_{y}b₁₃TCP_{z}+b₁₄[(Rotₐ−Rot_{b})]×[TCPXTCPYTCPX]^{T}=−[t_{ā}−t_{b̅}]
Using in at least three different robot positions, the above equation is applied to find TCP_{X}, TCPy, TCP_{Z}. Thus, PTCPHTFCS is obtained.

30. 3D vector calculation with transformation matrices behind the auto teaching software algorithm of a object holding and positioning system according to claim 26, characterised in that, In order to define the coordinate system attached the robot for a part no 1;
Homogeneous Transformation Matrix of plane in related to base of robot is named as PLANEHBASE,
Homogeneous Transformation Matrix of tool flange coordinate system in related to base of robot is named as TFCSHBASE,
Homogeneous Transformation Matrix of tool center point of probe in related to tool flange coordinate system of robot is named as PTCPHTFCS,
TFCSHBASE [symbol] BASEHTFCS
PTCPHTFCS→TFCSHPTCP
BASEHTFCS×TFCSHPTCP=BASEHPTCP
PLANEHBASE×BASEHPTCP=PLANEHPTCP
BASEHPTCP [symbol] PTCPHBASE
PLANEHPTCP×PTCPHBASE=PLANEHBASE
Above given formula is used to define coordinate frame for any object in the space.
